(19) United States
(12) Patent Application Publication
(10) Pub. No.: US 2007/0247795 A1
(43) Pub. Date: Oct. 25, 2007

(54) HEIGHT ADJUSTABLE SUPPORT APPARATUS AND DISPLAY WITH THE SAME

(76) Inventor: Li-Tien Tseng, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/697,897

(22) Filed: Apr. 9, 2007

(30) Foreign Application Priority Data
Apr. 12, 2006 (TW) 095112926

(51) Int. Cl. G06F 1/16

(52) U.S. Cl. 361/681

(57) ABSTRACT

The invention provides a height adjustable support apparatus and a display with the same. The height adjustable support apparatus includes a frame device, a slide member, a supporting device, and a constant force device, and a vertical direction is defined on the frame device. The frame device provides a first slide along the vertical direction. The slide member is engaged within the frame device and deviates from the vertical direction in an angle θ and provides a second slide. The supporting device includes a supporting member for mounting an object, a clamping member for clamping the constant force device, and a guide member for sliding within the first slide. The constant force device urges against the second slide via a compressible rod. The object together with the supporting device and the constant force device are moved upward or downward by applying an external force on the object to make the compressible rod compressed or released.

### BACKGROUND OF THE INVENTION

1. Field of the invention

The present invention relates to a height adjustable support apparatus and a display with the height adjustable support apparatus. The height adjustable support apparatus can adjust the height of an object, and in particular, the height adjustable support apparatus can be applied to objects with different weights.

2. Description of the prior art

In the current scope of support apparatuses for supporting objects, it is often seen to directly mount an object on a support apparatus; that is to say, the relative position of the object will not change unless the object is re-mounted. An improved method is to mount an object on a constant force device of a support apparatus. The constant force device can be a constant force spring. The object, therefore, can be adjustably mounted by deforming the constant force device. The constant force device may be hung on the support apparatus or disposed on the bottom of the support apparatus to support the weight of the object. However, the improved method can only be directed to objects with a certain weight or objects with weights within a very small changing range. If we want to change to another object with a different weight, the elastic member needs to be replaced to match the weight of the object. This limitation shrinks the application range and causes inconveniences in the use of the support apparatus.

Accordingly, the scope of the invention provides an adjustable support apparatus for objects with different weights, so as to solve the problem mentioned above.

### SUMMARY OF THE INVENTION

One scope of the invention provides a height adjustable support apparatus.

Another scope of the invention provides a support apparatus that can be applied to objects with different weights.

According to a preferred embodiment of the invention, a height adjustable support apparatus includes a frame device, a slide member, a supporting device, and a constant force device, and a vertical direction and a horizontal direction are defined on the frame device. The frame device provides a first slide along the vertical direction. The slide member is engaged into the frame device, and it deviates from the vertical direction in an angle θ, and thereon provides a second slide, whose opening faces the first slide. The supporting device includes a supporting member disposed outside the frame device, a clamping member, and a guide member. An object is capable of being mounted on the supporting member. The clamping member is mounted on the back of the supporting member. The guide member protrudes from the supporting member and limitedly slides within the first slide. The constant force device includes a body and a compressible rod. The body is clamped by the clamping member and disposed substantially parallel to the horizontal direction. The compressible rod is engaged to the body and has a distal end urging against the second slide. The constant force device can be a gas spring or a constant force spring.

Therefore, the object together with the supporting device and the constant force device move upward or downward by applying an external force on the object to make the compressible rod compressed or released. Therein, the constant force device applies a force F on the slide member along the horizontal direction, so the weight of the object is about F·tanθ.

Furthermore, the frame device includes a base member and a top member. The base member is disposed substantially along the horizontal direction and provides a lead screw. The top member is disposed opposite to the base member. The slide member is pivotally engaged to the top member through a top end and is engaged to the lead screw of the base member through a tail end. The angle θ varies by operating the lead screw so that the height adjustable support apparatus can support objects with different weights.

According to another preferred embodiment of the invention, a height adjustable support apparatus includes a first slide, a second slide, a supporting device, and a retractable device. The first slide extends along a first direction. The second slide has a top end and a bottom end, and it extends along a second direction. There is an angle θ between the first direction and the second direction; the distance between the top end of the second slide and the first slide is larger than that between the bottom end of the second slide and the first slide. The supporting device is moveably engaged to the first slide and slides on the first slide, and the supporting device can support an object. The retractable device includes a first end and a second end. The first end is fixed on the supporting device. The second end is moveably engaged to the second slide and slides on the second slide.

Therein, when the supporting device slides toward the top end of the second slide, the length of the retractable device increases, or when the supporting device slides toward the bottom end of the second slide, the length of the retractable device decreases, which makes the retractable device provide an upward supporting force to compensate the downward gravity of the object.

According to another preferred embodiment, the retractable device can be a gas spring or a constant force spring. If the first direction is vertical, and the retractable device applies a force F perpendicular to the first direction on the second slide, the weight of the object is about F·tanθ.

Furthermore, the height adjustable support apparatus includes a base member and a top member. The base member is engaged substantially perpendicular to the first direction to the first slide, and thereon provides a lead screw. The top member is opposite to the base member and engaged substantially perpendicular to the first direction to the first slide. The top end of the second slide is pivotally engaged to the top member. The bottom end of the second slide is adjustably engaged to the lead screw of the base member. The angle θ varies by operating the lead screw so that the height adjustable support apparatus can support objects with different weights.

Therefore, the height adjustable support apparatus according to the invention can not only support an object and adjust the height of the object but also be applied to supporting objects with different weights.

The advantage and spirit of the invention may be further understood by the following recitations together with the appended drawings.

### BRIEF DESCRIPTION OF THE APPENDED DRAWINGS

FIG. 1A is an external perspective view of the height adjustable support apparatus according to the first preferred embodiment of the invention.

FIG. 1B is a schematic diagram illustrating the height adjustable support apparatus according to the first preferred embodiment of the invention.

FIG. 1C is a schematic diagram illustrating the lifting and the lowering of the height adjustable support apparatus according to the first preferred embodiment of the invention.

FIG. 2A is a schematic diagram illustrating the height adjustable support apparatus according to the second preferred embodiment of the invention.

FIG. 2B is a schematic diagram illustrating the height adjustable support apparatus according to the third preferred embodiment of the invention.

FIG. 3 is a schematic diagram illustrating the reinforcement of the height adjustable support apparatus according to the first preferred embodiment.

FIG. 4A is a schematic diagram illustrating the height adjustable support apparatus according to the fourth preferred embodiment of the invention.

FIG. 4B is an external perspective view according to the fourth preferred embodiment of the invention.

FIG. 5 is a schematic diagram illustrating the reinforcement of the height adjustable support apparatus according to the fourth preferred embodiment.

### DETAILED DESCRIPTION OF THE INVENTION

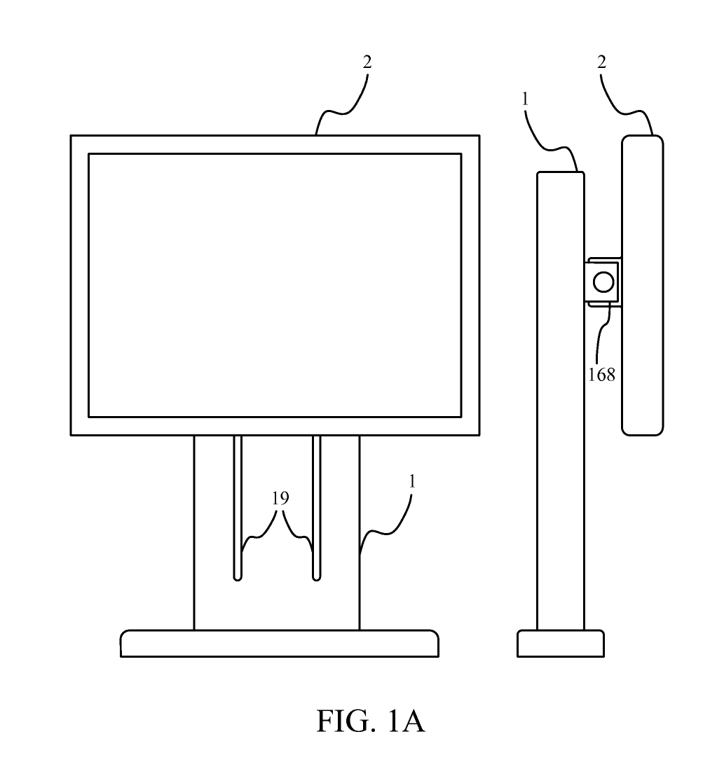

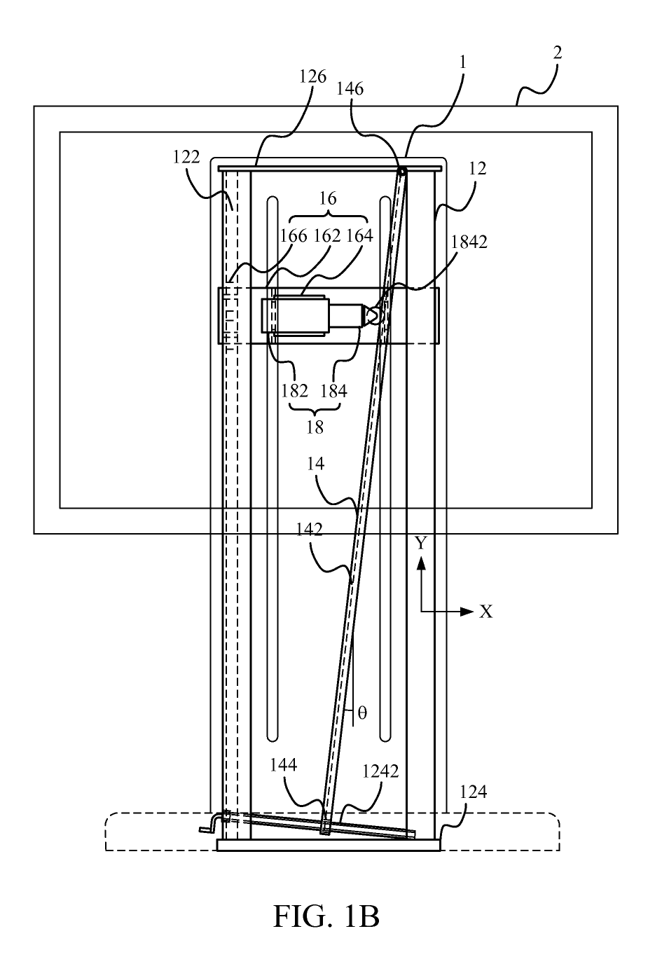

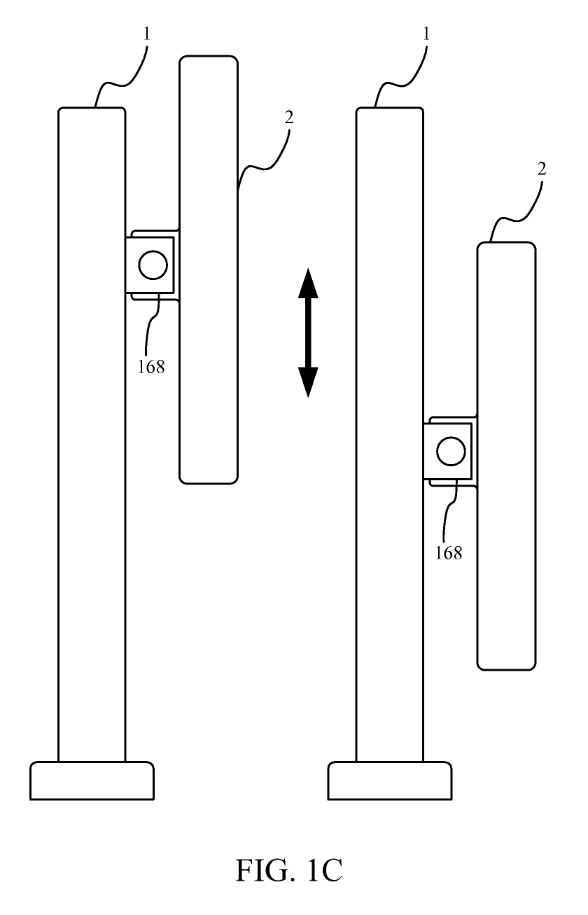

Referring to FIG. 1A to 1C, FIG. 1A is an external perspective view of a first preferred embodiment according to of the invention. FIG. 1B is a schematic diagram illustrating a height adjustable support apparatus according to the first preferred embodiment of the invention. FIG. 1C is a schematic diagram illustrating the lifting and the lowering of the height adjustable support apparatus according to the first preferred embodiment of the invention. The height adjustable support apparatus 1 includes a frame device 12, a slide member 14, a supporting device 16, and a constant force device 18, and a vertical direction Y and a horizontal direction X are defined on the frame device 12. The frame device 12 provides a first slide 122 along the vertical direction Y. The slide member 14 is engaged within the frame device 12 and deviates from the vertical direction Y in an angle θ, and thereon provides a second slide 142, whose opening faces toward the first slide 122. The supporting device 16 includes a supporting member 162 disposed outside the frame device 12, a clamping member 164, and a guide member 166. An object 2 is capable of being mounted on two extended arms 168 of the supporting member 162. The clamping member 164 is mounted on the back of the supporting member 162. The guide member 166 protrudes from the supporting member 162 and limitedly slides within the first slide 122. The constant force device 18 includes a body 182 and a compressible rod 184. The body 182 is clamped on the clamping member 164 and is disposed substantially along the horizontal direction X. The compressible rod 184 connects to the body 182 and has a distal end 1842 urging against the second slide 142. The constant force device 18 can be a gas spring, a constant force spring, or other constant force retractable devices. Incidentally, according to the first preferred embodiment, the object 2 is a screen, and the height adjustable support apparatus 1 includes housing for protection, which are illustrated in dashed lines except in FIG. 1A and FIG. 1C. The housing thereon has two slots 19 for allowing the two extended arm 168 to extend outside the housing and to move upward and downward with the screen. Whereby, the housing protects the fingers of a user from being jammed by the supporting device when the device is being moved, so as to increase the safety of the operation.

Therefore, the object 2 together with the supporting device 16 and the constant force device 18 move upward or downward by applying an external force on the object 2 to make the compressible rod 184 compressed or released. Therein, the constant force device 18 applies a force F on the slide member along the horizontal direction, so the weight of the object is about F·tanθ.

According to the first preferred embodiment, the frame device 12 further includes a base member 124 and top member 126. The base member 124 is disposed substantially along the horizontal direction X and provides a lead screw 1242. The top member 126 is disposed opposite to the base member 124. The slide member 14 is engaged to the lead screw 1242 of the base member 124 through a tail end 144, and it is pivotally engaged to the top member 126 through a top end 146. The angle θ varies by operating the lead screw 1242 so that the height adjustable support apparatus 1 can support the object 2 of a different weight.

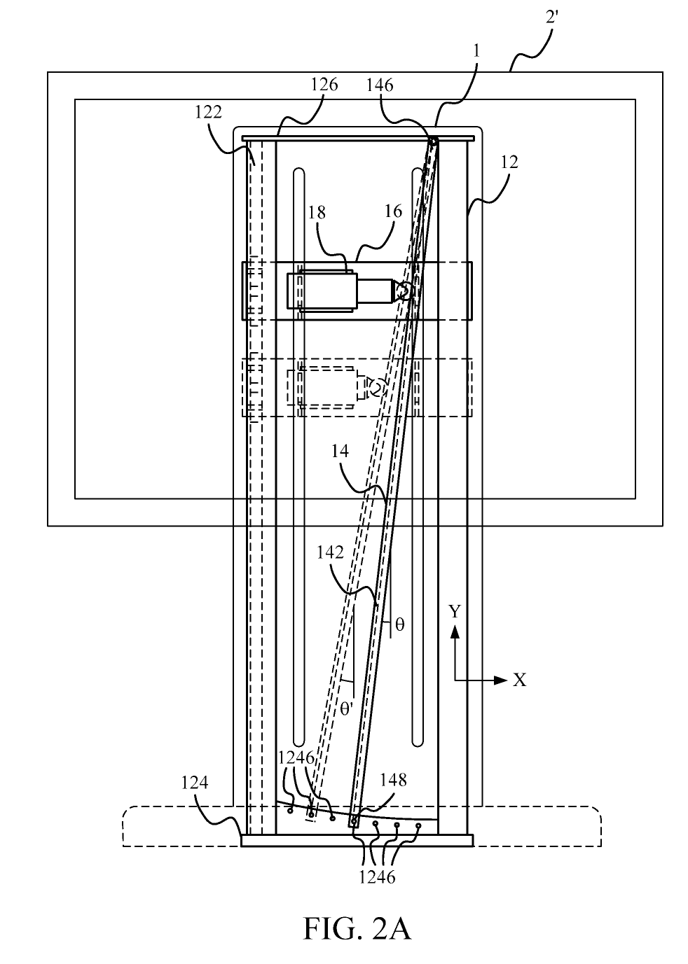

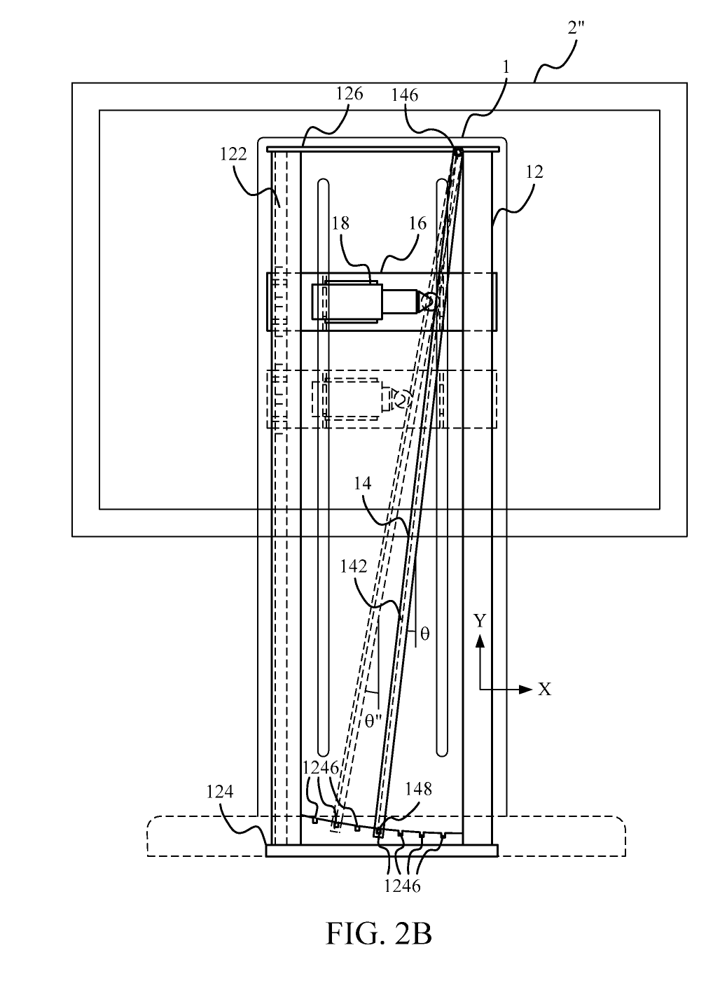

Referring to FIG. 2A, FIG. 2A is a schematic diagram illustrating a height adjustable support apparatus 1 according to a second preferred embodiment of the invention. Comparing the second preferred embodiment with the first preferred embodiment, the base member 124 of the frame device 12 can interchangeably provide a plurality of locating slots 1244, and the tail end 144 of the slide member 14 correspondingly includes a locating pin 148. The tail end 144 of the slide member 14 is engaged to the base member 124 by inserting the locating pin 148 into one of the locating slots 1244. The angle θ varies by inserting the locating pin 148 into the different one of the locating slots 1244. As shown by the dashed lines in FIG. 2A, the tail end 144 of the slide member 14 is located in another locating slot 1244 to make the angle θ′ different from the original angle θ, so that the height adjustable support apparatus 1 can support an object 2′ of a different weight. The weight of the object 2′is about F·tanθ′.

Referring to FIG. 2B, FIG. 2B is a schematic diagram illustrating a height adjustable support apparatus 1 according to a third preferred embodiment of the invention. Comparing the third preferred embodiment with the first preferred embodiment, similarly, the base member 124 of the frame device 12 can interchangeably provide a plurality of pin holes 1246, and the tail end 144 of the slide member 14 correspondingly includes a locating pin 148. The tail end 144 of the slide member 14 is engaged to the base member 124 by inserting the locating pin 148 into one of the pin holes 1246. The angle θ varies by inserting the locating pin 148 into the different one of the pin holes 1246. As shown by the dashed lines in FIG. 2B, the tail end 144 of the slide member 14 is located in another pin hole 1246 to make the angle θ″ different from the original angle θ, so that the height adjustable support apparatus 1 can support an object 2″ of a different weight. The weight of the object 2″ is about F·tanθ″.

The second preferred embodiment and the third preferred embodiment mentioned above, similar to the first preferred embodiment, the height of the object 2 can be adjusted at the same angle θ.

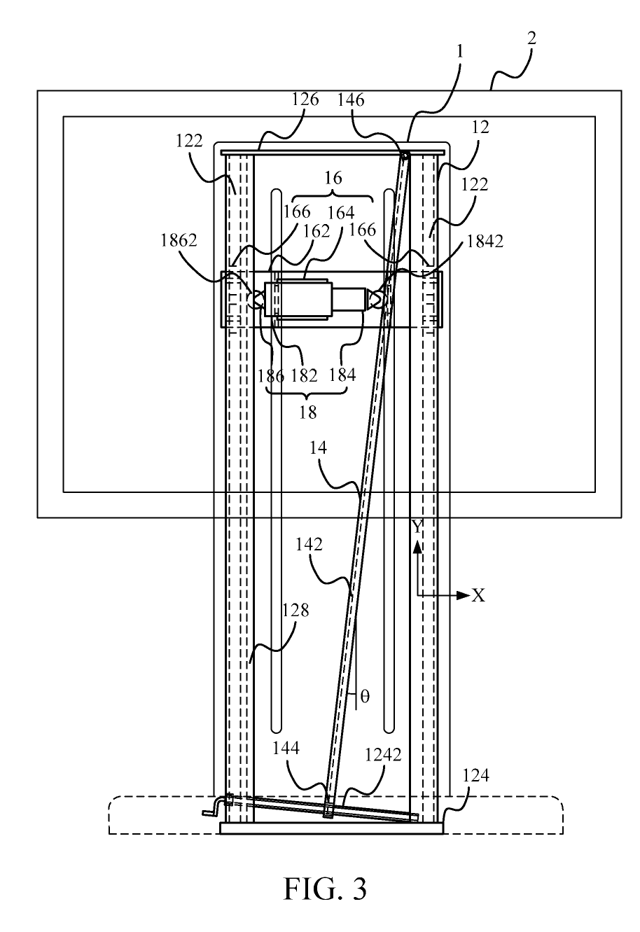

Further, according to the first preferred embodiment, the frame device 12 of the height adjustable support apparatus 1 can provide a plurality of first slides 122 or another second slide 128, or both of them, to enhance the stability and the strength of the structure, as shown in FIG. 3. FIG. 3 is a schematic diagram of enhancing the structure of the height adjustable support apparatus 1 according to the first preferred embodiment. In this case, the supporting device 16 correspondingly includes a plurality of corresponding guide members 166. The constant force device 18 also includes an auxiliary rod 186 corresponding to the second slide 128. The auxiliary rod 186 urges against the corresponding second slide 128 via a tail end 1862. Therein, the locations of the first slides 122 are not limited to corresponsive exterior sides. The sizes of which are also not necessarily the same but depend on actual demands. This consideration is also applied to the second preferred embodiment and the third preferred embodiment.

Besides, it should be clarified that although the weight of the object 2 is about F·tanθ, if the frictional force is involved, the height adjustable support apparatus 1 can still support the object 2 of a weight within a certain range for the same constant force device 18 with the same constant force and the same angle θ. When the adjustable angle θ is also applied, the weight range of the object easily applying to the height adjustable support apparatus 1 is quite wide.

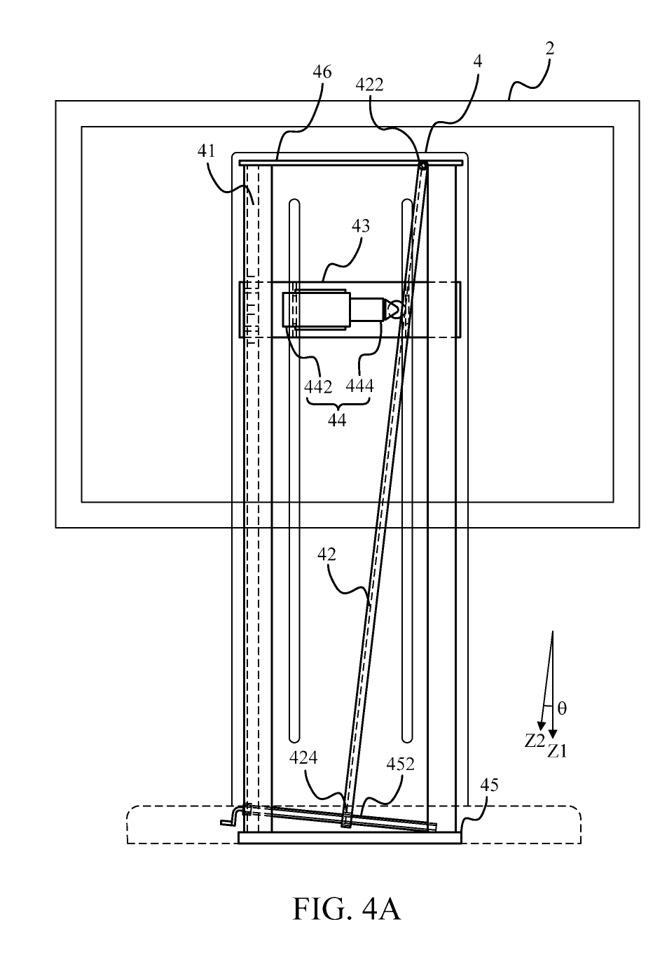

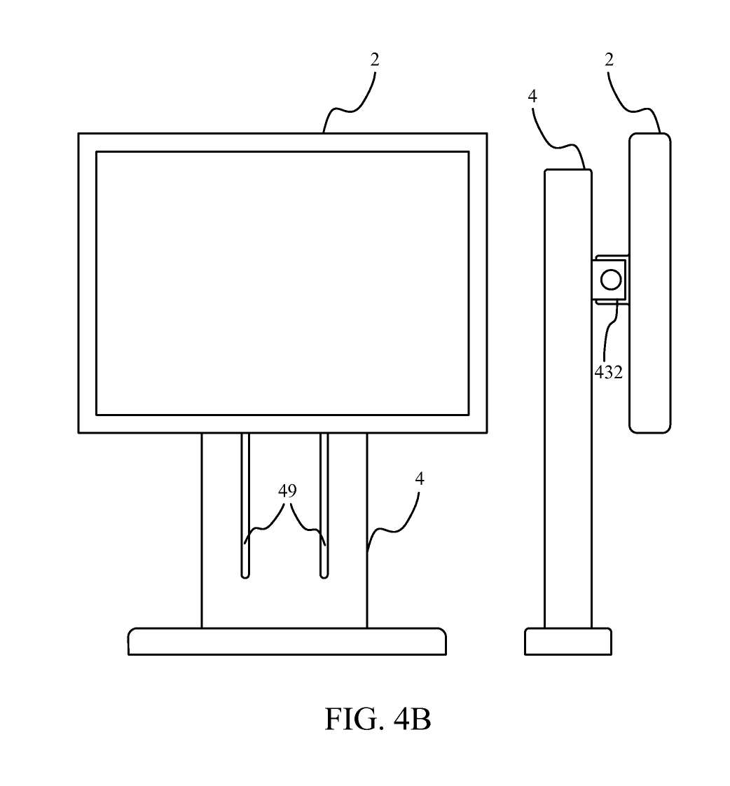

Referring to FIG. 4A and FIG. 4B, FIG. 4A is a schematic diagram illustrating a height adjustable support apparatus according to a fourth preferred embodiment of the invention. FIG. 4B is an external perspective view according to the fourth preferred embodiment of the invention. According to the fourth preferred embodiment, the height adjustable support apparatus 4 includes a first slide 41, a second slide 42, a supporting device 43, and a retractable device 44. The first slide 42 extends along a first direction Z1. The second slide 42 includes a top end 422 and a bottom end 424 and extends along a second direction Z2. There is an angle θ between the first direction Z1 and the second direction Z2, and the distance between the top end 422 of the second slide 42 and the first slide 41 is greater than that between the bottom end 424 of the second slide 42 and the first slide 41. The supporting device 43 is movably engaged to the first slide 41 and can slide on the first slide 41. The supporting device 43 is capable of supporting an object. The retractable device 44 includes a first end 442 and second end 444. The first end 442 is fixed on the supporting device 43. The second end 444 is movably engaged to the second slide 42 and can slide on the second slide 42. Incidentally, according to the fourth preferred embodiment, the object 2 is a screen, and the height adjustable support apparatus 4 includes a housing for protection, as shown in dashed line in FIG. 4A. The housing thereon has two slots 49 for allowing the two extended arms 432 to extend outside the housing and to move upward and downward with the screen. Whereby, the housing protects the fingers of a user from being jammed by the supporting device when the device is being moved, so as to increase the safety of the operating.

Therein, when the supporting device 43 slides toward the top end 422 of the second slide 42, the length of the retractable device 44 increases; or when the supporting device 43 slides toward the bottom end 424 of the second slide 42, the length of the retractable device 44 decreases, which allows the retractable device 44 to provide an upward supporting force to compensate the downward gravity of the object.

According to the fourth preferred embodiment, the retractable device can be a gas spring or a constant force spring. If the first direction is a vertical direction, and the retractable device applies a force F perpendicular to the first direction on the second slide, the weight of the object is about F·tanθ.

Furthermore, the height adjustable support apparatus 4 includes a bottom member 45 and top member 46. The bottom member 45 is engaged substantially in a direction perpendicular to the first direction Z1 to the first slide 41 and thereon provides a lead screw 452. The top member 46 is opposite to the base member 45 and is engaged substantially in a direction perpendicular to the first direction Z1 to the first slide 41. The top end 422 of the second slide 42 is pivotally engaged to the top member 46. The bottom end 424 of the second slide 42 is adjustably engaged to the lead screw 452 of the bottom member 45. The angle θ varies by operating the lead screw 452 so that the height adjustable support apparatus 4 can support objects with different weights.

With the same principles in the second and the third preferred embodiments, the bottom member 45 can also interchangeably provide a plurality of locating slots or pin holes, and the second slide 42 correspondingly provides a locating pin, which achieves the purpose of varying the angle θ.

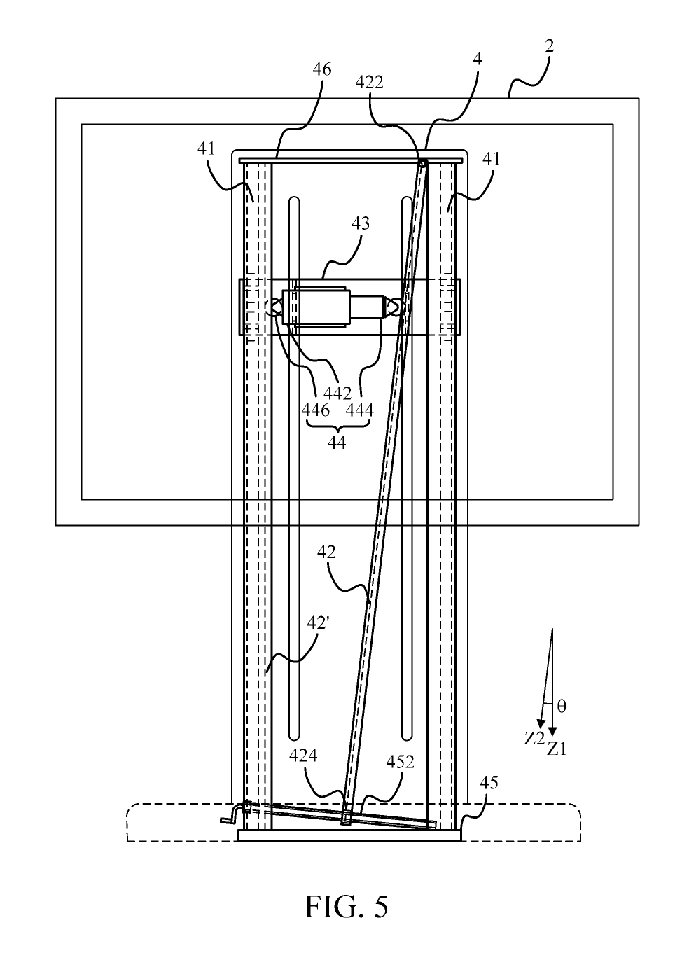

Besides, according to the fourth preferred embodiment, the height adjustable support apparatus 4 can provide a plurality of first slides 41 or another second slide 42′, or both of them, to enhance the stability and the strength of the structure, as shown in FIG. 5. FIG. 5 is a schematic diagram illustrating the height adjustable support apparatus 4 according to the fourth preferred embodiment. The second slide 42′ can be independent or be achieved by merging into one of the first slides 41 as a physical member. In this case, the supporting device 43 can be movably and correspondingly engaged to the first slides 41. The retractable device 44 correspondingly to the another second slide 42′ also includes a third end 446. The third end 446 extends from the first end 442 of the retractable device 44 and is opposite to the second end 444. The third end 446 is movably engaged to the second slide 42′. Therein, the locations of the first slides 41 are not limited to corresponsive exterior sides, the sizes of which are not necessarily the same but depend on actual demands.

Therefore, the height adjustable support apparatus according to the invention can not only support an object and adjust the height of the object but also be applied to the supporting of objects with different weight ranges by adjusting the angle.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. An height adjustable support apparatus, comprising:
a frame device thereon defining a vertical direction and a horizontal direction, the frame device thereon providing a first slide extending along the vertical direction;
a slide member, the slide member being engaged to the frame device and departing from the vertical direction in an angle θ, the slide member thereon providing an second slide, the second slide facing toward the first slide;
a supporting device comprising a supporting member disposed outside the frame device, an object being capable of being mounted on the supporting member, the supporting device also comprising a clamping member and a guide member, the clamping being mounted on the back of the supporting member so as to be disposed within the frame device, the guide member protruding from the supporting member and limitedly sliding within the first slide; and
a constant force device comprising a body and a compressible rod, the body being clamped by the clamping member and disposed along the horizontal direction, the compressible rod being engaged to the body and comprising a distal end urging against the second slide;
wherein the lifting or the lowering of the object together with the supporting device and the constant force device is actuated by applying an external force on the object to make the compressible rod compressed or released so as to move the object along the vertical direction upward or downward.

2. The height adjustable support apparatus of claim 1, wherein the constant force is a gas spring or a constant force spring.

3. The height adjustable support apparatus of claim 1, wherein the constant force device applies a force F along the horizontal direction on the slide member, and the weight of the object is about F·tanθ.

4. The height adjustable support apparatus of claim 1, wherein the frame device comprises a base member and a top member, the base member is disposed substantially along the horizontal direction, the top member is disposed opposite to the base member, and the slide member comprises a top end pivotally engaged to the top member and a tail end adjustably engaged to the base member such that the angle θ of the slide member deviating from the vertical direction is capable of being varied.

5. The height adjustable support apparatus of claim 4, wherein the base member provides a lead screw, and the slide member is engaged via the tail end thereof to the lead screw, whereby the angle θ is varied by operating the lead screw.

6. The height adjustable support apparatus of claim 4, wherein the base member provides a plurality of locating slots or pin holes, the tail end of the slide member comprises a locating pin, and the tail end of the slide member is engaged to the base member by inserting the locating pin through one of the locating slots or the pin holes, whereby the angle θ is varied by inserting the locating pin through the different one of the locating slots or the pin holes.

7. An height adjustable support apparatus, comprising:
a first slide extending along a first direction;
a second slide comprising a top end and bottom end, the second slide extending along a second direction, there being an angle θ between the first direction and the second direction, the distance between the top end of the second slide and the first slide being greater than that between the bottom end of the second slide and the first slide;
a supporting device, the supporting device being movably engaged to the first slide and sliding on the first slide, the supporting device being capable of supporting an object; and
a retractable device comprising a first end fixed on the supporting device and a second end movably engaged to the second slide and sliding on the second slide;
wherein when the supporting device slides toward the top end of the second slide, the length of the retractable device increases, and when the supporting device slides toward the bottom end of the second slide, the length of the retractable device decreases, which allows the retractable device to provide an upward supporting force to compensate the downward gravity of the object.

8. The height adjustable support apparatus of claim 7, wherein the retractable device is a gas spring or a constant force spring.

9. The height adjustable support apparatus of claim 7, wherein the retractable device applies a force F perpendicular to the first direction on the second slide, and the weight of the object is about F·tanθ.

10. The height adjustable support apparatus of claim 7, further comprising a base member and a top member, the base member being engaged substantially perpendicular to the first direction to the first slide, the top member being engaged opposite to the base member and substantially perpendicular to the first direction to the first slide, the top end of the second slide being pivotally engaged to the top member, the bottom end of the second slide being adjustably engaged to the base member such that the angle θ is capable of being varied.

11. The height adjustable support apparatus of claim 10, wherein the base member provides a lead screw and the second slide is engaged via the bottom end thereof to the lead screw, whereby the angle θ is varied by operating the lead screw.

12. The height adjustable support apparatus of claim 10, wherein the base member provides a plurality of the locating slots or pin holes, the bottom end of the second slide comprises a locating pin, and the bottom end of the second slide is engaged to the base member by inserting the locating pin through one of the locating slots or the pin holes, whereby the angle θ is varied by inserting the locating pin through the different one of the locating slots or the pin holes.

13. An height adjustable display apparatus, comprising:
a screen;
a base member;
a first slide disposed on the base member, the first slide extending along a first direction;
a second slide comprising a top end and bottom end, the second slide extending along a second direction, there being an angle θ between the first direction and the second direction, the distance between the top end of the second slide and the first slide being greater than that between the bottom end of the second slide and the first slide;
a supporting device, the supporting device being movably engaged to the first slide and sliding on the first slide, the supporting device being capable of supporting the screen; and
a retractable device comprising a first end fixed on the supporting device and a second end movably engaged to the second slide and sliding on the second slide;
wherein when the supporting device slides toward the top end of the second slide, the length of the retractable device increases, or when the supporting device slides toward the bottom end of the second slide, the length of the retractable device decreases, which allows the retractable device to provide an upward supporting force to compensate the downward gravity of the object.

14. The height adjustable display apparatus of claim 13, wherein the retractable device is a gas spring or a constant force spring.

15. The height adjustable display apparatus of claim 13, wherein the retractable device applies a force F perpendicular to the first direction on the second slide, and the weight of the screen is about F·tanθ.

16. The height adjustable display apparatus of claim 13, further comprising a top member, the top member being engaged opposite to the base member and substantially perpendicular to the first direction to the first slide, the top end of the second slide being pivotally engaged to the top member, the bottom end of the second slide being adjustably engaged to the base member such that the angle θ is capable of being varied.

17. The height adjustable display apparatus of claim 16, wherein the base member provides a lead screw and the second slide is engaged via the bottom end thereof to the lead screw, whereby the angle θ is varied by operating the lead screw.

18. The height adjustable display apparatus of claim 16, wherein the base member provides a plurality of locating slots or pin holes, the bottom end of the second slide comprises a locating pin, and the bottom end of the second slide is engaged to the base member by inserting the locating pin through one of the locating slots or the pin holes, whereby the angle θ is varied by inserting the locating pin through the different one of the locating slots or pin holes.

19. The height adjustable display apparatus of claim 13, further comprising a housing, the housing comprising a slot, the supporting device further comprising an extended arm, the extended arm passing through the slot to connect the screen and the supporting device, the extended arm being capable of moving upward and downward together with the screen in the slot.
